(19) United States
(12) Patent Application Publication
(10) Pub. No.: US 2025/0118880 A1
(43) Pub. Date: Apr. 10, 2025

(54) RECHARGEABLE POWER CELL FILL PORT AND FILL PORT PLUG

(71) Applicant: GM Global Technology Operations LLC, Detroit, MI (US)

(72) Inventors: Hwanchul Kim, Dryden, MI (US); Subrahmanyam Goriparti, Troy, MI (US); Vincent Edward Herrman, Clawson, MI (US); Youngmin Chung, Troy, MI (US)

(21) Appl. No.: 18/480,793

(22) Filed: Oct. 4, 2023

(51) Int. Cl. H01M 50/645; H01M 50/103; H01M 50/15; H01M 50/193

(52) U.S. Cl. CPC H01M 50/645; H01M 50/103; H01M 50/15; H01M 50/193

(57) ABSTRACT

A power cell includes a plurality of anode, cathode and separator sheets arranged as layers and disposed within a container. An anode terminal protrudes from the layers, and a cathode terminal protrudes from the layers. A cover plate seals the container and includes a first fill port. A reusable fill port plug is disposed within the first fill port. The reusable fill port plug has a threaded shaft extending axially from a head along an axis defined by the threaded shaft and a compressible seal disposed about the threaded shaft and contacting the head.

### INTRODUCTION

The subject disclosure relates to power cells for rechargeable batteries, such as those used in electric or hybrid electric vehicles, and more specifically to a fill port and reusable fill port plug for the same.

Vehicles, including electric and hybrid electric vehicles, feature battery storage for purposes such as powering electric motors, electronics and other vehicle subsystems. Batteries for the battery storage system typically include multiple distinct power cells, each of which stores power. The power cells are electrically connected to provide an output power. In some examples, each power cell includes a lithium-ion, or similar, structure including an electrolyte fluid that is filled into the power cell structure after the structure has been assembled. Due to the nature of electrolyte fluids, this process requires multiple filling steps during which the fill port should be switched between sealed and unsealed. Current techniques use a disposable temporary fill port plug that is discarded each time the battery cell is unsealed, and a permanent seal that can be installed once the filling operation is complete.

Accordingly, it is desirable to provide a fill port sealing configuration for a lithium ion, or similar, power cell structures that reduces cost and waste associated with disposable temporary fill port plugs during the fill process.

### SUMMARY

In one exemplary embodiment a power cell includes a plurality of anode, cathode and separator sheets arranged as a plurality of layers and disposed within a container, an anode terminal protruding from the plurality of layers, a cathode terminal protruding from the plurality of layers, a cover plate sealing the container, the cover plate including a first fill port, and a reusable fill port plug disposed within the first fill port, the reusable fill port plug having a threaded shaft extending axially from a head along an axis defined by the threaded shaft and a compressible seal disposed about the threaded shaft and contacting the head.

In addition to one or more of the features described herein the at least one fill port comprises a through hole having a first threaded portion interfaced with the threaded shaft and a second portion receiving the head.

In addition to one or more of the features described herein the second portion is countersunk and wherein the head is flush with an exterior surface of the power cell.

In addition to one or more of the features described some examples include a fill port plate disposed exterior to, and covering, the head, wherein the fill port plate is affixed to the cover plate.

In addition to one or more of the features described herein the fill port plate is affixed to the cover plate via one of a weld and an epoxy.

In addition to one or more of the features described herein the compressible seal is comprised of one of silicon and polyphenylene sulfide.

In addition to one or more of the features described herein the head further includes an intrusion have a cross section of one of a rectangle, a plus, a star, a slot, a hexagon, a triangle, and an oval.

In addition to one or more of the features described herein the threaded shaft has threading between 0.05 and 0.5 mm pitch.

In addition to one or more of the features described herein the container is a prismatic container.

In addition to one or more of the features described herein the container is a cylindrical can.

In addition to one or more of the features described herein the cover plate comprises at least a second fill port, substantially identical to the first fill port.

In addition to one or more of the features described herein the threaded shaft is conical.

In addition to one or more of the features described herein the threaded shaft is cylindrical.

In another exemplary embodiment a method for filling a power cell includes injecting an electrolyte fluid into a power cell container through a first fill port until the power cell container is partially filled, closing the first fill port using a reusable fill port plug and allowing a pressure to build within the power cell container for a predetermined period of time, removing the reusable fill port plug after the predetermined period of time and allowing off-gasses to vent, re-inserting the reusable fill port plug, permanently fixing the reusable fill port plug in the first fill port.

In addition to one or more of the features described herein the threaded shaft is one of a conical shaft and a cylindrical shaft.

In addition to one or more of the features described herein the reusable fill port plug comprises having a threaded shaft extending axially from a head along an axis defined by the threaded shaft and a compressible seal disposed about the threaded shaft and contacting the head, and wherein the compressible seal is comprised of one of silicon and polyphenylene sulfide.

In addition to one or more of the features described herein permanently fixing the reusable fill port plug in the first fill port comprises covering a head of the reusable fill port plug with a fill port plate and welding the fill port plate to the power cell container.

In addition to one or more of the features described herein closing the first fill port using the reusable fill port plug comprises rotating the reusable fill port plug such that threading of the reusable fill port plug interfaces with threading of the first fill port and the compressible seal is compressed.

In addition to one or more of the features described herein injecting the electrolyte fluid into the power cell container through the first fill port until the power cell container is partially filled comprises venting gas from inside the container through a second fill port, the second fill port being substantially identical to the first fill port.

In addition to one or more of the features described herein closing the first fill port using a reusable fill port plug further comprises closing the second fill port with a second reusable fill port plug.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a vehicle including a battery-based energy storage system;

FIG. 2 is an exemplary power cell according to one embodiment;

FIG. 3 is an exemplary cover plate for the power cell of FIG. 2;

FIG. 4 is an exemplary reusable fill port seal for the cover plate of FIG. 3;

FIG. 5A is an exemplary inclusion shape for the fill port head of FIG. 4 according to one example;

FIG. 5B is an exemplary inclusion shape for the fill port head of FIG. 4 according to another example;

FIG. 5C is an exemplary inclusion shape for the fill port head of FIG. 4 according to another example;

FIG. 5D is an exemplary inclusion shape for the fill port head of FIG. 4 according to another example;

FIG. 5E is an exemplary inclusion shape for the fill port head of FIG. 4 according to another example;

FIG. 5F is an exemplary inclusion shape for the fill port head of FIG. 4 according to another example;

FIG. 5G is an exemplary inclusion shape for the fill port head of FIG. 4 according to another example; and

FIG. 6 illustrates an alternate power cell packaging utilizing an electrolyte fluid filling process during an assembly.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

In accordance with an exemplary embodiment, a rechargeable power cell for a vehicle battery system includes a fill port. The fill port is used during an assembly process to insert electrolyte fluid into the rechargeable battery, and to allow for off-gasses to vent out of the power cell. The fill port is sealed with a reusable fill port plug that can be removed to allow venting and then reinserted to reseal the power cell. The reusable fill port plug includes a threaded shaft connected to a head and a sealing element nesting against the head and disposed about the threaded shaft. In a final power cell assembly, a welding plate is disposed over the head and permanently affixed to the rechargeable battery housing. Alternatively, other structures permanently positioning the reusable fill port plug within the fill port can be used in a similar manner.

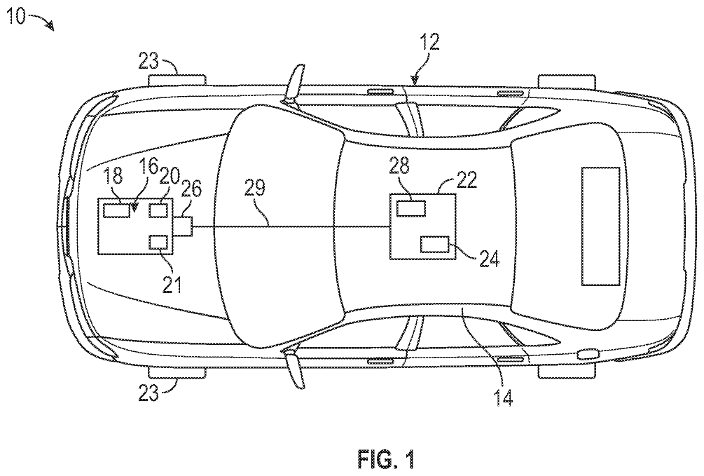

With continued reference to the general system described above, FIG. 1 shows an embodiment of a motor vehicle 10. The vehicle 10 includes a vehicle body 12 defining, at least in part, an occupant compartment 14. The vehicle body 12 also supports various vehicle subsystems including a propulsion system 16, a battery system 22, other subsystems to support functions of the propulsion system 16 and other vehicle components, such as a braking subsystem, a suspension system, a steering subsystem, a fuel injection subsystem, an exhaust subsystem and others.

The vehicle 10 may be a combustion engine vehicle, an electrically powered vehicle (EV) or a hybrid vehicle. In an embodiment, the vehicle 10 is a hybrid vehicle that includes a combustion engine system 18 and at least one electric motor assembly. For example, the propulsion system 16 includes a first electric motor 20 and a second electric motor 21. The motors 20 and 21 may be configured to drive wheels 23 on opposing sides of the vehicle 10. Any number of motors positioned at various additional locations about the vehicle 10 may be used to provide mechanical rotation to corresponding systems and subsystems.

The battery system 22 may be electrically connected to the motors 20 and 21 and/or other components, such as vehicle electronics. The battery system 22 may be configured as a rechargeable energy storage system (RESS), and includes multiple electrically connected power cells. A battery system controller 24 is included within the battery system 22 and controls the charging and discharging functions of the batteries within the battery system 22. In alternative configurations, the battery system controller 24 can be a general vehicle controller remote from the battery system 22 and configured to control multiple systems and/or subsystems. The general vehicle controller can be located at any position within the vehicle 10. In yet further alternatives, the battery system controller 24 can be a distributed control system including multiple coordinating controllers throughout the vehicle 10 encompassing controllers within the battery system 22 and controllers remote from the battery system 22.

In one embodiment, the battery system 22 includes one or more battery packs 28. The battery packs 28 include multiple distinct battery power cells connected to a power distribution bus 29 for providing power to one or more systems. In the exemplary system of FIG. 1, the power distribution bus 29 is illustrated in simplified form and provides power to the propulsion systems 16 through an inverter 26.

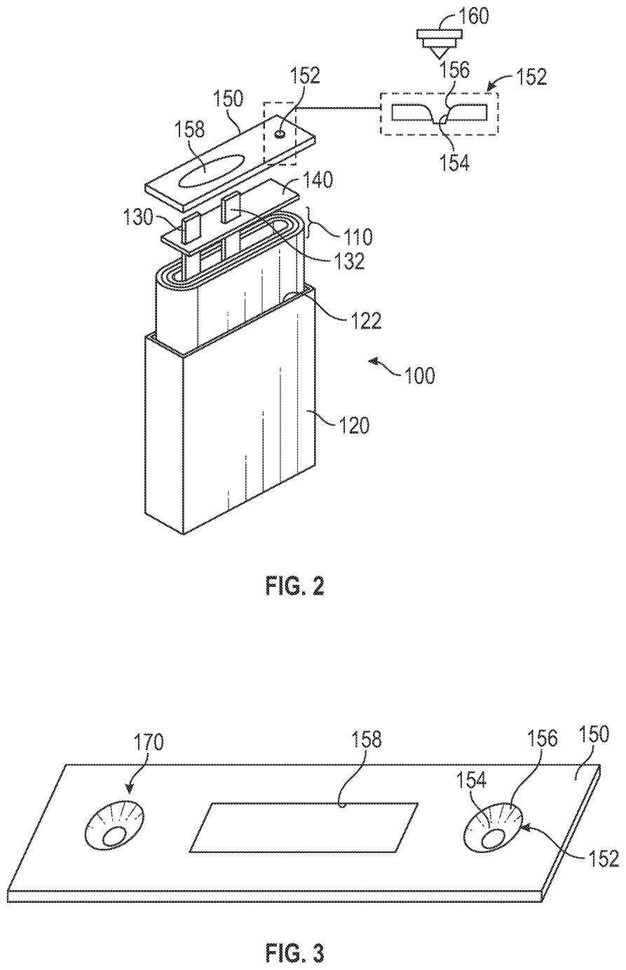

With continued reference to FIG. 1, FIG. 2 schematically illustrates a single power cell 100 as could be used in the battery pack 28. The illustrated power cell 100 is, in one example, a lithium-ion type rechargeable power cell. It is appreciated that the features disclosed herein are applicable to any power cell type utilizing electrolyte fluid and are not limited to lithium-ion based configurations specifically. The power cell 100 includes multiple anode, cathode and separator sheets 110 arranged as layers and positioned within a casing 120 according to known power cell configurations. The particular casing 120 is a rectangular prism, and the power cell 100 is referred to as a prismatic cell, or a prismatic battery, due to the shape of the casing 120. Inserted into the layers 110 are an anode 130 and a cathode 132. An insulator plate 140 insulates the anode 130 and the cathode 132 from the casing 120 and supports the anode 130 and the cathode 132.

A cover plate 150 is connected to the casing 120 and includes an opening 158 through which the anode 130 and the cathode 132 extend. The cover plate 150 can, in some examples, be constructed of the same material as the casing 120, with the material being selected to be non-conductive and to maintain structural integrity up to sufficient pressure levels. In some examples, the material is aluminum, stainless steel, or an alloy having similar electrical and structural properties. The opening 158 is sealed via the insulator plate 140.

A fill port 152 is included in the cover plate 150 and allows for an electrolyte fluid to be inserted into the power cell 100 as part of the assembly process. The fill port 152 includes a first portion 154 for receiving a threaded shaft of a reusable fill port plug and countersunk second portion 156 for receiving a head of the reusable fill port plug such that the reusable fill port plug is flush with the cover plate 150 in the final assembly.

With continued reference to the structure of FIG. 2, a typical simplified assembly process of the power cell 100 includes inserting the layers 110 and the anode 130 and cathode 132 into the casing 120 and securing the anode 130 and the cathode 132 in place using the insulating plate 140. Then, the cover plate 150 is positioned at an opening 122 of the casing 120 and sealed to the casing 120 using any appropriate epoxy, welding, or other adhesion. Once fully sealed, an electrolyte fluid is inserted into the container 120 through the fill port 152, with the smallest cross sectional area of the fill port 152 metering the flow of electrolyte fluid into the container 120. In one example, the smallest cross section is in the range of 2 to 3.5 mm (or, approximately, 0.07 to 0.14 in) in order to properly meter the flow.

The container 120 is partially filled with the electrolyte fluid, and a reusable fill port plug 160 is inserted into the fill port 152. After a predetermined delay has passed, the reusable fill port plug 160 is removed and off gases are allowed to escape. Once fully vented, the remaining space within the container 120 is filled with more electrolyte fluid through the fill port 152, and the same reusable fill port plug 160 is re-inserted into the fill port 152. The delay, off gassing, and refilling step may be repeated multiple times, depending on the design of the power cell 100.

After the fill process is completed, the reusable fill port plug 160 is reinserted into the fill port 152 and is sealed to the cover plate 150. In some examples, the seal can be via a plate welded to the cover plate 150 and placed above the reusable fill port plug 160. In alternate examples, the reusable fill port plug 160 can be sealed to the fill port 152 or to the cover plate 150 via an epoxy or any other suitable adhesive.

With continued reference to FIG. 2, FIG. 3 illustrates the cover plate 150 including a fill port 152 and an opening 158. In addition, the cover plate 150 illustrated in FIG. 3 illustrates an optional second fill port 170. The optional second fill port 170 can be used in some examples, as a vent to allow for quick fill through the first fill port 152 by keeping the optional second fill port 170 open during the filling process. During the sealing process, the optional second fill port 170 is filled and sealed in the same manner and using the same style reusable fill port plug 160 as the primary fill port 152.

With continued reference to FIGS. 1-3, FIG. 4 illustrates a side view of a reusable fill port plug 160 according to one example. The reusable fill port plug 160 includes a threaded shaft 410, a ring seal 420 disposed about an outer end of the threaded shafter 410, and a head 430. In the illustrated example, the shaft 410 is tapered inward in a generally conical shape, with a narrowest cross section 414 disposed at an end away from the head 430 and a wider cross section 412 disposed at the head 430. In alternative examples, the conical shaft 410 can be replaced with a cylindrical shaft. The illustrated threading 416 is exaggerated for illustrative effect, and the spacing and depth of the threading 416 in a practical example will be designed to maintain the reusable fill port plug 160 in place up to, and exceeding, the maximum expected pressure during the filling and venting operations. In one example, the threading 416 is configured to maintain the shaft 410 in position under at least 10 bar of pressure. In another example, the threading 416 is configured to maintain the shaft 410 in position under a pressure of 10-12 bar. In yet another example, the threading 416 has between 0.05 and 0.5 mm pitch, thereby ensuring sufficient strength to maintain proper pressure levels within the power cell 100. The material of the shaft 410 is selected to ensure that the threads 416 and the body of the shaft 410 are able to remain structurally sound while till withstanding sufficient pressure ranges. By way of example, the materials can include one of aluminum, stainless steel, and any similar alloys such as AL3003-H14.

The seal 420 is disposed about the shaft 410 and is compressed against the fill port 152 when the reusable fill port plug 160 is in a fully installed state. The ring seal 420 is constructed of either a rubber or a polymer composite (e.g. silicon, polyphenylene sulfide, etc.) and deforms when the reusable fill port plug 160 is in the fully installed state. The deformation causes the seal 420 to be compressed into and to close any gaps that may exist between the shaft 410 and the fill port 152. The particular material from which the seal 420 is constructed is selected to be compressible while at the same time withstanding the pressures that build up within the power cell 100 during repeated charge and discharge operations.

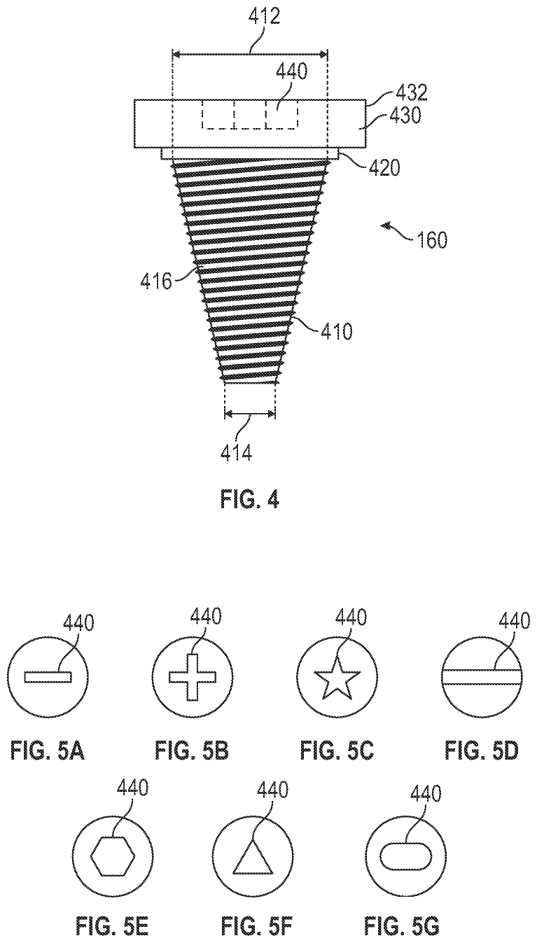

In some examples, such as the illustrated example, the head 430 includes straight circumferential edges 432. In alternative examples, the circumferential edges 432 can be angled inwards toward an axis defined by the shaft 410. The head 430 includes a cutout 440 for receiving a rotational tool and allowing the reusable fill port plug 160 to be rotated such that the rotation of the threads either pushes the shaft into the fill port 152 (with a first direction of rotation) or pulls the shaft 410 out of the fill port 152 (with a second direction of rotation opposite the first direction of rotation.) While the cutout 440 of the reusable fill port plug 160 of FIG. 4 is a cross, or plus, shaped cutout, it is appreciated that multiple different cutouts can be utilized. FIGS. 5A, 5B, 5C, 5D 5E, 5F, and 5G illustrate such options including a rectangle (FIG. 5A), the plus shape (FIG. 5B), a star (FIG. 5C), a slot (FIG. 5D), a hexagon (FIG. 5E), a triangle (FIG. 5F, and an oval (FIG. 5G).

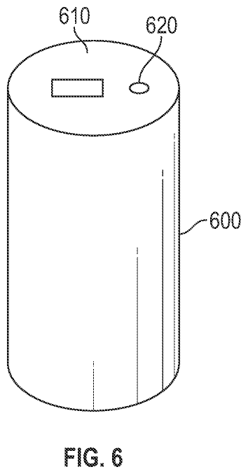

While described within the context of a prismatic power cell 100, it is appreciated that alternative power cells packaging, such as a can power cell 600 illustrated in FIG. 6 can include a similar cover plate 610 and fill port 620 construction. Such a construction can likewise benefit from the reusable fill port plug 160 described herein.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

Unless specified to the contrary within, schematic representations do not correspond one to one with physical structures, and the relative positioning, size, orientation, or other configurations of the components within the schematic representation are not limiting.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A power cell comprising:
a plurality of anode, cathode and separator sheets arranged as a plurality of layers and disposed within a container;
an anode terminal protruding from the plurality of layers;
a cathode terminal protruding from the plurality of layers;
a cover plate sealing the container, the cover plate including a first fill port; and
a reusable fill port plug disposed within the first fill port, the reusable fill port plug having a threaded shaft extending axially from a head along an axis defined by the threaded shaft and a compressible seal disposed about the threaded shaft and contacting the head.

2. The power cell of claim 1, where the at least one fill port comprises a through hole having a first threaded portion interfaced with the threaded shaft and a second portion receiving the head.

3. The power cell of claim 2, wherein the second portion is countersunk and wherein the head is flush with an exterior surface of the power cell.

4. The power cell of claim 3, further comprising a fill port plate disposed exterior to, and covering, the head, wherein the fill port plate is affixed to the cover plate.

5. The power cell of claim 4, wherein the fill port plate is affixed to the cover plate via one of a weld and an epoxy.

6. The power cell of claim 1, wherein the compressible seal is comprised of one of silicon and polyphenylene sulfide.

7. The power cell of claim 1, wherein the head further includes an intrusion have a cross section of one of a rectangle, a plus, a star, a slot, a hexagon, a triangle, and an oval.

8. The power cell of claim 1, wherein the threaded shaft has threading between 0.05 and 0.5 mm pitch.

9. The power cell of claim 1, wherein the container is a prismatic container.

10. The power cell of claim 1, wherein the container is a cylindrical can.

11. The power cell of claim 1, wherein the cover plate comprises at least a second fill port, substantially identical to the first fill port.

12. The power cell of claim 1, wherein the threaded shaft is conical.

13. The power cell of claim 1, wherein the threaded shaft is cylindrical.

14. A method for filling a power cell comprising:
injecting an electrolyte fluid into a power cell container through a first fill port until the power cell container is partially filled;
closing the first fill port using a reusable fill port plug and allowing a pressure to build within the power cell container for a predetermined period of time;
removing the reusable fill port plug after the predetermined period of time and allowing off-gasses to vent;
re-inserting the reusable fill port plug; and
permanently fixing the reusable fill port plug in the first fill port.

15. The method of claim 14, wherein the reusable fill port plug comprises having a threaded shaft extending axially from a head along an axis defined by the threaded shaft and a compressible seal disposed about the threaded shaft and contacting the head, and wherein the compressible seal is comprised of one of silicon and polyphenylene sulfide.

16. The method of claim 15, wherein the threaded shaft is one of a conical shaft and a cylindrical shaft.

17. The method of claim 14, wherein permanently fixing the reusable fill port plug in the first fill port comprises covering a head of the reusable fill port plug with a fill port plate and welding the fill port plate to the power cell container.

18. The method of claim 14, wherein closing the first fill port using the reusable fill port plug comprises rotating the reusable fill port plug such that threading of the reusable fill port plug interfaces with threading of the first fill port and the compressible seal is compressed.

19. The method of claim 14, wherein injecting the electrolyte fluid into the power cell container through the first fill port until the power cell container is partially filled comprises venting gas from inside the container through a second fill port, the second fill port being substantially identical to the first fill port.

20. The method of claim 19, wherein closing the first fill port using a reusable fill port plug further comprises closing the second fill port with a second reusable fill port plug.
